(19) United States
(12) Patent Application Publication
(10) Pub. No.: US 2010/0320377 A1
(43) Pub. Date: Dec. 23, 2010

(54) LOW VOLTAGE, HIGH MASS RANGE ION TRAP SPECTROMETER AND ANALYZING METHODS USING SUCH A DEVICE

(75) Inventors: Robert J. Cotter, Baltimore, MD (US); Luann Becker, Baltimore, MD (US); William B. Brinckerhoff, Ellicott City, MD (US)

Correspondence Address: EDWARDS ANGELL PALMER & DODGE LLP, P.O. BOX 55874, BOSTON, MA, 02205, US

(73) Assignee: The Johns Hopkins University, Baltimore, MD (US)

(21) Appl. No.: 12/742,252

(22) PCT Filed: Nov. 10, 2008
(86) PCT No.: PCT/US2008/012638

§ 371 Date: Aug. 30, 2010

Related U.S. Application Data
(60) Provisional application No. 61/002,568, filed on Nov. 9, 2007.

(51) Int. Cl. H01J 49/42; B01D 59/44

(52) U.S. Cl. 250/283; 250/292

(57) ABSTRACT

Featured is a quadrupole ion trap mass spectrometer having a compact configuration with a low voltage fundamental RF and using supplemental RF to a very low q_{ejec} value so as to yield a device characterized as having a high mass range. In more particular embodiments, such a quadrupole ion trap mass spectrometer is configured and arranged so as to a mass range on the order of 1,000 to 2,500 Da. Also featured are methods embodying the use of such a quadrupole ion trap mass spectrometer.

This application claims the benefit of U.S. Provisional Application Ser. No. 61/002,568 filed Nov. 9, 2007, the teachings of which are incorporated herein by reference.

### STATEMENT REGARDING FEDERALLY-SPONSORED RESEARCH

The present invention was supported by grants from the National Aeronautical and Space Administration (NASA), grant number NNG04GC17G. The U.S. Government may have certain rights to the present invention.

### FIELD OF INVENTION

The present invention generally relates to ion trap mass spectrometers and mass analyzing methods related thereto more particularly to an ion trap mass spectrometer having a low fundamental voltage and a high mass range and yet more particularly to low voltage, compact quadrupole ion trap mass spectrometer that achieves a mass range of 2,000 Da by utilizing a supplemental excitation mode to substantially lower the ion stability boundary for high masses at low voltage.

### BACKGROUND OF THE INVENTION

Mass spectrometers are analytical instruments that measure the masses of individual molecules and/or their fragments to identify specific chemical/biological compounds or to determine their structures. These instruments have been in biological research to determine (for example) the amino acid sequences of peptides or the complex arrangements of sugars in carbohydrates. These instruments also have been used in environmental applications to determine the presence and concentrations of air, soil and water pollutants, in forensics for crime scene investigations or drug interdiction, for homeland security to determine the presence of explosives or chemical/biological weapons, for clinical diagnostics and to determine drug use in the racing industry or by athletes. In addition, these instruments have been used for a variety of space applications.

Mass spectrometers accomplish these analyses by first converting molecules into charged species (ions) and then measuring their mass-to-charge ratios (m/z) in a mass analyzer. Thus, mass spectrometers can be characterized both by the ionization methods used and the means by which the m/z is determined. In particular, some of the ionization methods commonly used today include electron ionization (EI), chemical ionization (CI), laser methods such as laser desorption (LD), matrix-assisted laser desorption/ionization (MALDI) and multiphoton ionization (MPI), and particle beam methods known generally as secondary ion mass spectrometry (SIMS). EI is the most commonly used method for combined gas chromatography/mass spectrometry (GC/MS) instruments and for relatively low molecular weight volatile compounds. CI is used for similar applications but produces less fragmentation. MPI also produces less fragmentation but is selective for polyaromatic species, or chromophores. LD and MALDI work directly with non-volatile, solid samples with mass ranges up to 3,000 and 500,000 Daltons, respectively. Common mass analyzers include magnetic sectors, quadrupoles, time-of-flight (TOF) mass spectrometers and quadrupole ion traps (QITs). For the most part, both ionization sources and mass analyzers are operated under very high vacuum.

In regards to space applications, magnetic sector analyzers were used in the Viking missions to Mars [Biemann, K., et al., The Search for Organic Substances and Inorganic Volatile Compounds in the Surface of Mars, J. Geophysical Res. 82 (1977) 4641; Soffen, G. A., The Viking Project, J. Geophysical Res. 82 (1977) 3959]. These instruments utilized a permanent magnet system that required little power, though miniaturization did limit their mass range.

The so-called neutral mass spectrometer (NMS) designed by Alfred O. Nier and launched Aug. 20, 1975 was a double-focusing (electrostatic and magnetic) mass spectrometer used to measure the concentrations of species in the Mars atmosphere. It utilized electron ionization and had two collectors monitoring the mass ranges 1-7 Da and 7-49 Da. The GCMS designed by Klaus Biemann and launched Sep. 9, 1975 was to examine substances vaporized from heated soil and had a 12-200 Da mass range.

Miniaturized quadrupoles were used in the ion/neutral mass spectrometer (INMS) in the orbiter launched in 1997 as part of the Cassini Mission to Saturn/Titan, and as well in the Huygens Probe aerosol pyrolyzer GCMS. The mass range on these instruments was from 1-99 Da. Several mass spectrometers are on board the Rosetta mission to intercept the comet Churyumov-Gerasimenko in 2014. The COSIMA (cometary dust secondary ion mass analyzer) is a TOF-SIMS instrument, while two sensors on the ROSINA (Rosetta orbiter spectrometer for ion and neutral analysis) include a reflectron TOF mass spectrometer and a quadrupole ion trap-based GCMS. The ion trap is of reduced size using low voltage (300 V), low frequency RF to achieve a mass range of around 150 Da.

Most of the instruments used in space applications operate at space vacuum (a fortuitous situation that obviates the need for a vacuum pumping system) or introduce the sample into a vacuum chamber prior to both ionization and mass analysis. Thus, the GCMS instruments (for example) provide an interface between the effluent from the gas chromatograph to the high vacuum mass spectrometer.

In addition to those described above, there are many other examples of mass spectrometers in which an attempt was made to reduce the overall size of the package. For example, a novel sector instrument based upon a crossed field (E×B) design by Diaz, Giese and Gentry [Diaz, J. A.; Giese, C. F.; Gentry, W. R., Sub-miniature ExB sector-field mass spectrometer, J. Am. Soc. Mass Spectrom. 12 (2001) 619-632] has been developed as a residual gas analyzer with applications ranging from space to the monitoring of evolved gases on the Kilauea volcano in Hawaii. Microelectromechanical systems (MEMS) technology has been utilized in the fabrication of quadrupole mass analyzers [Taylor, S.; Tindall, R. F.; Syms, R. R. A., Silicon Based Quadrupole Mass Spectrometer Using Microelectromechanical Systems, J. Vac. Sci. Technol. 8 (2001) 557-562], and multiple quadrupole mass analyzers have been assembled in bundles, or as arrays [Boumsellek, S.; Ferran, R. J., Miniature Quadrupole Arrays for Residual and Process Gas Analysis, J. Inst. Env. Sci. Tech. 42 (1999) 27]. Quadrupole ion traps have perhaps been the most miniaturized instruments in the number of reports on the subject and the ultimate reduction in size. The laboratories of J. Michael Ramsey [Patterson, G. E.; Guyman, A. J.; Riter, L. S.; Everly, M.; Griep-Raming, J.; Laughlin, B. C.; Ouyang, Z.; Cooks, R. G., Miniature Cylindrical Ion Trap Mass Spectrometer, Anal. Chem. 74 (2002) 6145-6153] and R. Graham Cooks [Pau, S.; Pai, C. S.; Low, Y. L.; Moxom, J.; Reilly, P. T. A.; Whitten, W. B.; Ramsey, J. M., Microfabricated Quadrupole Ion Trap for Mass Spectrometer Applications, Phys. Rev. Lett. 96 (2006) 120801] have developed multiple cylindrical ion trap arrays on a chip. There have also been reports of micro-sized TOF mass spectrometers [Yoon, H. Y.; Kim, J. H.; Choi, E. S.; Yang, S. S.; Jung, K. W., Fabrication of a novel micro time-of-flight mass spectrometer, Sensors and Actuators A 97-98 (2002) 441-447]. However, in all of these compact and miniaturized instruments, mass range is greatly reduced, along with other performance characteristics such as mass resolution and accuracy. Relatively compact (1-3 inch) TOF mass spectrometers with very high mass range have been described [Prieto, M. C.; Kovtoun, V. V. and Cotter, R. J., Miniaturized Linear Time-of-Flight Mass Spectrometer with Pulsed Extraction. J. Mass Spectrom. 37 (2002) 1158-1162; Cornish, T. J. and Cotter, R. J., High Order Kinetic Energy Focusing in Endcap Reflectron Time-of-Flight Mass Spectrometer. Anal. Chem. 69 (1997) 4615-4618; U.S. Pat. No. 5,814,813]. However, high mass range is achieved using high accelerating voltages (10-20 kV), which are incompatible with use for direct, external ionization in the Mars atmosphere. As to the cylindrical arrays developed by the Oak Ridge and Purdue groups, the required mass ranges are achieved from the small r₀ and lower RF frequency. In the Rosetta instrument only a fundamental RF is employed with a concurrent reduction in mass range to 150 Dalton (Da).

It thus would be desirable to provide a new ion trap mass spectrometer and methods for analyzing using such a mass spectrometer. It would be particularly desirable to provide such a device that would employ a low voltage fundamental RF in comparison and a supplemental RF providing a very low q_{ejec} value so as to yield a device characterized as having a high mass range as compared to prior art devices. Such mass spectrometers preferably would be simple in construction and less costly than prior art devices and such methods would not require highly skilled users to utilize the device.

### SUMMARY OF THE INVENTION

The present invention features a quadrupole ion trap mass spectrometer having a compact configuration with a low voltage fundamental RF and using a supplemental RF to a very low q_{ejec} value so as to yield a device characterized as having a high mass range. In more particular embodiments, such a quadrupole ion trap mass spectrometer is configured and arranged so as to have a mass range on the order of 1,000 to 2,500 Da. Also featured are methods embodying the use of such a quadrupole ion trap mass spectrometer.

According to one aspect of the present invention there is featured a quadrupole ion trap for mass spectrometry that includes a ring electrode having an aperture, a plurality of end cap electrodes that are arranged so at least one endcap electrode is opposed to the ring electrode aperture, a first RF power supply and a a second RF power supply. The first RF power supply is operably coupled to the ring electrode so as to form a quadrupole field for trapping ions within a storage volume defined by said field. The second RF power supply is operably coupled to a pair of end cap electrodes.

The first RF power supply supplies a first RF voltage having an amplitude less than or equal to 1,000 v. The second RF power supply supplies a second RF voltage, the second voltage having a voltage and/or frequency set so that the ion trap exhibits a mass range from about 0 Da to at least about 1,000 Da. Alternatively, the ion trap exhibits a mass range from a low mass cut off to at least about 1,000 Da. In this regard, reference hereinafter to 0 Da as a lower end of the mass range also shall be understood to include a low mass cut off point.

In particular embodiments, the first RF voltage has an amplitude that is one of less than or equal to about 750 v, an amplitude less than or equal to about 500 v or an amplitude less than or equal to about 300 v.

In particular embodiments, the second RF voltage and/or frequency is established so that the ion trap exhibits a mass range one of from about 0 Da to at least about 1,500 Da, from about 0 Da to at least about 2,000 Da, or from about 0 Da to at least about 2,500 Da. In more particular embodiments, the frequency of the second RF voltage is set so as to yield a q_{ejec} value that in combination with the mass range established by the first RF voltage yields an ion trap having a mass range one of from about 0 Da to at least about 1,500 Da, from about 0 Da to at least about 2,000 Da, or from about 0 Da to at least about 2,500 Da.

In further embodiments, the radius of the ring electrode aperture (r₀) and the distance from a center of the ion trap (z₀) and the endcap electrode are established such that these values combined with the frequency and amplitude of the first RF voltage establish a first mass range. In more particular embodiments, r₀ is less than 1 cm and z₀ is less than 1 cm; r₀ is less than about 0.8 cm and z₀ is less than about 0.8 cm; r₀ is less than 0.7 cm and z₀ is less than 0.8 cm; or r₀ is about 0.5 cm and z₀ is about 0.5 cm.

In further embodiments, such a quadrupole ion trap further includes a bath gas that is disposed in the storage volume. The bath gas includes any one of air, carbon dioxide, oxygen, nitrogen or a noble gas such as helium, xenon and argon. The bath gas also includes combinations of any two or more of air, carbon dioxide, oxygen, nitrogen or a noble gas such as helium, xenon and argon.

According to another aspect of the present invention there is featured a mass spectrometry apparatus for providing one or more outputs representing a mass analysis of a sample. Such a mass spectrometry apparatus includes any of the quadrupole ion traps as described herein. Such an apparatus also includes a means for ionizing the sample, where the means is operably coupled to the quadruple ion trap such that the ionized sample is trapped in the storage volume. Such an apparatus further includes a means for detecting ions and providing an output signal representative of the detected ions and a means for controlling the quadrupole ion trap so as to cause one or more ions to be ejected from the storage volume to the detector.

According to yet another aspect of the present invention, there is featured yet another mass spectrometry apparatus for providing one or more outputs representing a mass analysis of a sample. Such a mass spectrometry apparatus includes a quadrupole ion trap for mass spectrometry; a means for ionizing the sample, said means being operably coupled to the quadruple ion trap such that the ionized sample is trapped in the storage volume; a means for detecting ions and providing an output signal representative of the detected ions; and a means for controlling the quadrupole ion trap so as to cause one or more ions to be ejected from the storage volume to the detector.

Such a quadrupole ion trap includes a ring electrode having an aperture, a plurality of end cap electrodes that are arranged so at least one endcap electrode is opposed to the ring electrode aperture, a first RF power supply, and a second RF power supply. The first RF power supply is operably coupled to the ring electrode so as to form a quadrupole field for trapping ions within a storage volume defined by said field and supplies a first RF voltage having an amplitude less than or equal to 500V. A radius of the ring electrode aperture (r₀) is about 0.5 cm and a distance (z₀) from a center of the ion trap and the endcap electrode is about 0.5 cm and these values combined with the frequency and amplitude of the first RF voltage establish a first mass range.

The second RF power supply is operably coupled to a pair of end cap electrodes and supplies a second RF voltage to the pair of endcap electrodes. The second RF voltage having a frequency set so as to yield a q_{ejec} value that in combination with the first mass range yields an ion trap having a overall mass range from about 0 Da to at least about 1,000 Da.

In further embodiments, the frequency of the second RF voltage is set so as to yield a q_{ejec} value that in combination with the first mass range established yields an ion trap having an overall mass range one of from about 0 Da to at least about 1,500 Da, from about 0 Da to at least about 2,000 Da, or from about 0 Da to at least about 2,500 Da.

Also featured are mass spectrometry apparatuses embodying such ion traps and methods related thereto.

Other aspects and embodiments of the invention are discussed below.

### DEFINITIONS

The instant invention is most clearly understood with reference to the following definitions:

Dalton (Da) is a unit of atomic mass that is defined as being a unit of molecular mass approximately equal to the mass of a hydrogen atom, a unit of mass equal to 1/12 the mass of the most abundant isotope of carbon, carbon 12, which is assigned a mass of 12 or a unit of atomic mass equivalent to 1/16 the mass of an oxygen atom. The term Dalton also is now replaced by the atomic mass unit.

Tandem mass spectrometry, also known as MS/MS, involves multiple steps of mass spectrometry selection, with some form of fragmentation occurring in between the stages. Multiple stages of mass analysis separation can be accomplished with individual mass spectrometer elements separated in space or in a single mass spectrometer with the MS steps separated in time. In tandem mass spectrometry in space, the separation elements are physically separated and distinct, although there is a connection between the elements to maintain high vacuum. These elements can be sectors, transmission quadrupole, or time-of-flight. In a tandem mass spectrometry in time instrument, the separation is accomplished with ions trapped in the same place, with multiple separation steps taking place over time. A quadrupole ion trap or FTMS instrument can be used for such an analysis. Trapping instruments can perform multiple steps of analysis, which is sometimes referred to as MSⁿ (MS to the n). Often the number of steps, n, is not indicated, but occasionally the value is specified; for example MS³ indicates three stages of separation

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1 is a schematic view of a basic ion trap.

FIG. 2 is a diagrammatic view of ion trap stability.

FIG. 3 is a schematic view of an ion trap with a supplemental RF voltage applied to the endcap electrodes.

FIG. 4 is a mass spectrometry apparatus according to one embodiment of the present invention.

FIG. 5 is a mass spectrometry apparatus according to another embodiment of the present invention.

FIG. 6 is a diagrammatic view of an ion trap mass spectrum of Ultramark standard obtained on an LCQ classic using CO₂ as a buffer gas.

FIGS. 7A,B are diagrammatic views of an applied logarithmic sweep of frequency with time (FIG. 7A) and of the theoretical secular frequency as a function of mass (FIG. 7B).

FIG. 8 is a schematic view of a low voltage ion trap mass spectrometer illustrating the external ionization source and internal ionization using an electron source on the ring electrode. Both means of ionization use identical electron sources consisting of a filament assembly in a cylindrical insert with an exit hole for the electron beam. In the external EI source, the filament is biased at −70V with respect to the cylindrical insert (and the source block), and the ions are pulsed into the trap using the repeller and ion extraction lenses. In the internal EI mode, the electron beam is pulsed from (typically)-60V (ON) to +240V (OFF).

FIG. 9A-C are various diagrammatic views of the mass spectrum of PFTBA: FIG. 9A raw spectrum in time, FIG. 9B frequency spectrum and FIG. 9C theoretical transformed linear scale mass spectrum. The characteristic mass peaks of PFTBA are marked in parentheses above which is provided the mass “shift” based on the theoretical peak assignments. The right axis of FIG. 9C shows the corresponding mass scan rate imposed by the logarithmic frequency sweep.

FIG. 10 is a diagrammatic view of mass spectra obtained using a logarithmic scan of the supplemental waveform from 375 kHz to 15 kHz with varying amplitudes of 2, 3, 4, 5 and 7 Vₚ₋ₚ. Peaks emerge earlier at higher frequencies with increasing supplemental waveform amplitude.

FIG. 11 is a diagrammatic view of a forward scan (curve #2) and a reverse scan (curve #1) show a marked difference in resolution for a sample of xenon gas. The isotopes of xenon are clearly visible in the forward scan which benefits from non-linear effects.

FIG. 12 is a diagrammatic view showing the fundamental RF trapping voltage is adjusted to 248 Vₚ₋ₚ, 341 Vₚ₋ₚ, and 391 Vₚ₋ₚ.

FIG. 13 is a diagrammatic view of a series of slow scans is performed with the resulting mass spectra for scan rates of 1000 Da/s (curve #1), ˜500 Da/s (curve #2), and 250 Da/s (curve #3) by doubling and then quadrupling the scan duration.

FIG. 14 is a diagrammatic view of an EI mass spectrum of PSS-Octakis(dimethylsyliloxy)-substituted silsesquioxane in the region of m/z 1000.

FIGS. 15A,B are diagrammatic views of mass spectra with CO₂ as the bath gas: FIG. 15A internal ionization using an electron source mounted on the ring electrode, and FIG. 15B electron ionization in an external source. The black (curve #1) and red (curve #2) traces demonstrate the corresponding fundamental RF amplitudes 166 V₀₋ₚ and 238 V₀₋ₚ (respectively).

FIG. 16 is a diagrammatic view of a concentration study of CO₂ as bath gas on the internal EI signal of PFTBA.

### DESCRIPTION OF THE PREFERRED EMBODIMENT

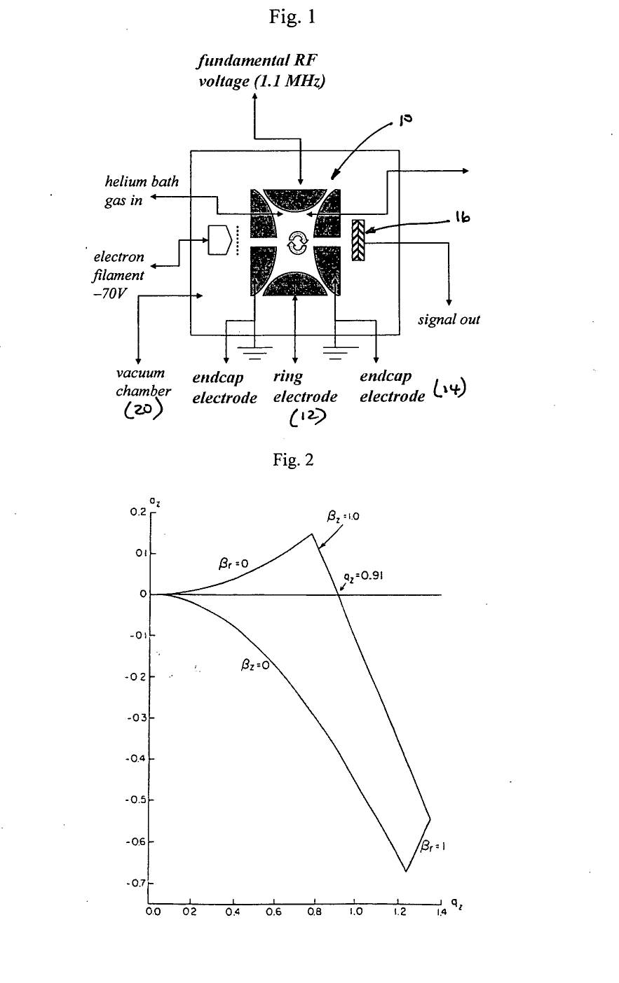

As introduction, an overview discussion as to ion trap mass spectrometry is first provided. In the following, like reference characters refer to like parts. The quadrupole ion trap was invented in the late 1950s by Wolfgang Paul from the University of Bonn Paul [German Patent 944,900; U.S. Pat. No. 2,939,952]. Initially, little attention was given to this invention, but, more than 30 years later the Royal Swedish Academy of Science awarded Paul the Nobel prize in Physics for his development of the ion trap. As shown in FIG. 1, the basic ion trap 10 is relatively simple, consisting of a central donut-shaped ring electrode 12 capped along each end of the axis by two endcap electrodes 14 that is disposed in a vacuum chamber 20. An RF voltage 11 is applied to the ring electrode 12 that is used to trap the ions. A detector 16 is provided to detect the ions coming from the ion trap.

Recognition of the potential of the quadrupole ion trap as a mass spectrometer came in 1983 with the discovery of the mass-selective instability mode of operation [U.S. Pat. No. 4,540,884]. The Finnigan Corporation (Sunnyvale, Calif.) produced a commercial version of the quadrupole ion trap of known as the ion trap detector (ITD), since it was used primarily as a low cost mass selective detector for gas chromatography.

The operation of the ion trap as a mass spectrometer can be appreciated by reference to a so-called stability diagram as shown in FIG. 2. If there is an RF voltage V on the ring electrode 12 and a DC voltage bias U on the endcap electrodes 14, then the Matthieu parameters q_{z} and a_{z}: are used to designate the axes. In the case in which the endcap electrodes 14 are at ground (the horizontal line a_{z}=0 in FIG. 2) an increase in the RF amplitude moves the ions along this line toward the stability boundary when q_{z}=0.91. Scanning the RF voltage will cause an ion of mass/charge m/z to become unstable when:

$$m / z = \frac{8 V}{( ( {r}_{0}^{2} + 2 {z}_{0}^{2} ) {Ω}_{0}^{2} {q}_{z}}$$

This is the mass selective instability mode, and was the only mode available on the initial ITD instruments. Typically, these and later commercial instruments have an RF frequency Cl₀ equal to 1.1 MHz, a maximum amplitude V_{MAX} equal to 7.5 kV₀₋ₚ, a radius r₀=1.0 cm, and an axial dimension 2z₀=r₀. The mass range is then 650 Da. In operation, ions are trapped at much lower than the maximum amplitude during a period of several milliseconds when the ions are kinetically and internal cooled by collisions with helium bath gas 2 (FIG. 1) at a pressure of about 1 mTorr. Scanning by increasing the RF amplitude then causes ions of increasing mass to become unstable. The maximum mass that can be scanned out of the ion trap is then given by:

$${( m / z )}_{max} = \frac{4 {V}_{max}}{( {q}_{eject} {r}_{0}^{2} {Ω}^{2} )}$$

when r₀²=2z₀², or the more general equation:

$${( m / z )}_{max} = \frac{8 {V}_{max}}{{q}_{eject} {Ω}^{2} ( {r}_{0}^{2} + 2 {z}_{0}^{2} )}$$

when for example r₀=1 and z₀=0.783 cm. Note that masses higher than 650 Da may be trapped using these standard parameter, but the voltage amplitude used (7.5 kV) will drive masses across the stability boundary only up to 650 Da. There are a number of ways to increase the mass range. Increasing V, above 7.5 kV will increase the mass range, but higher voltages are often not practical, and certainly not in the context of decreasing the operating voltage. Other possibilities are to decrease the fundamental frequency or the dimensions of the trap. For example, an instrument reported by Cooks et al [Kaiser R E, Jr., Cooks R G, Moss J, Hemberger P H, Mass Range Extension in a Quadrupole Ion-trap Mass Spectrometer, Rapid Commun. Mass Spectrom. 3, (1989) 50-53] extends the mass range to 2,600 Da by decreasing the dimensions r₀ and z₀ by one half, gaining in essence a factor of 4 in mass. The frequency and amplitude of the fundamental RF in this case remain the same. The Rosetta instrument noted above in the Background discussion has an RF amplitude of only 300 volts (compared with the conventional 7.5 kV), but achieves a mass range of 150 by dropping the frequency to 600 kHz and the dimension r₀ to 0.8 cm.

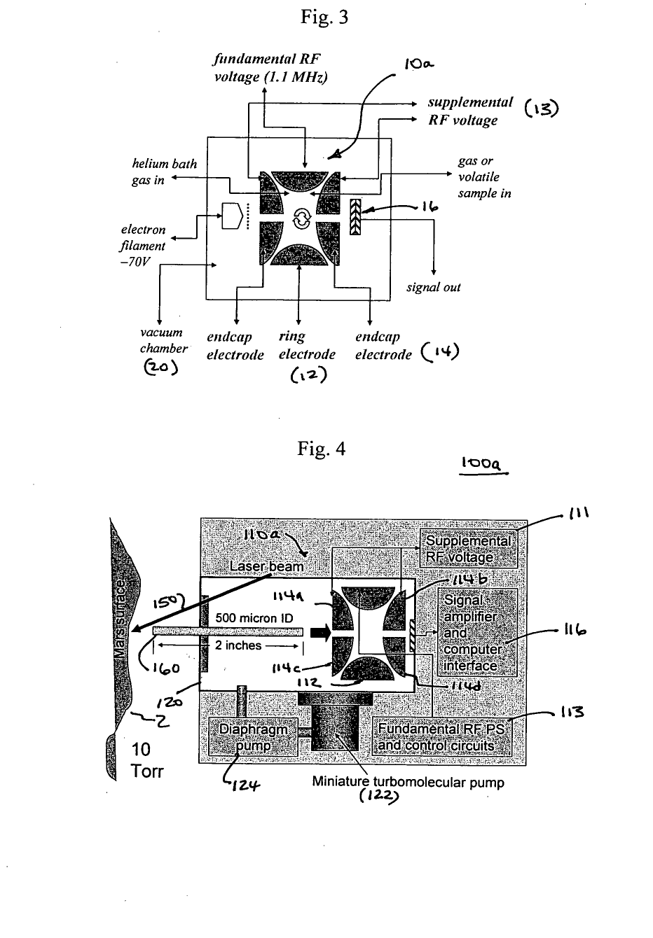

As indicated herein, the mass range also can be increased by the application of a voltage to the endcaps or endcap electrodes, and scanning the fundament RF voltage so that ions become unstable at a different point along the stability diagram (see FIG. 2). Axial excitation was first described in U.S. Pat. No. 4,736,101 for a method intended to provide enhanced mass resolution. In this method a bipolar, supplementary, low amplitude RF voltage 13 is applied to the end-cap electrodes 14 of a ion trap 10a as shown in FIG. 3. The dipole electric field strongly affects the motion of ions of a particular mass/charge, if the frequency of this field is in resonance with the frequency of their oscillation in the z direction. If the amplitude and duration of the supplementary RF excitation are small, then the ions exhibit an increase in their amplitude of oscillation, but continue to have stable trajectories. If one increases the amplitude or duration of the excitation, however, ions in resonance will exit the trap in the z-direction and be registered by the detector.

Since the resonant frequency depends upon the amplitude of the trapping RF field, one may obtain a mass spectrum by scanning the amplitude of the RF voltage 11 applied to the ring electrode. Thus, the scanning process for this resonance ejection mode is similar to that used for the mass selective instability mode of operation. However, in this case ions can be ejected at any point along the q_{z} axis lying within the stability diagram (FIG. 2), while in the mass selective instability mode they exit the trap along the extreme right point along the q_{z} axis, where it intersects the boundary of stability region. Any mass may be ejected by this method using an appropriate choice of the frequency of the exciting voltage.

In effect the mass range is increased because the supplemental RF 13 applied to the endcap electrodes 14 is used to lower the q_{eject}. For example, a supplementary RF=69.9 kHz applied to the standard Finnigan configuration results in a q_{eject}=0.182, and the maximum mass then becomes: m/z=(0.91/0.182)×650=5×650=3,250 Da. A supplementary RF=35.2 kHz would result in a q_{eject}=0.091 and m/z=(0.91/0.091)×650=10×650=6,500, with the fundamental RF still set at 1.1 MHz and 7.5 kV amplitude.

A supplemental voltage can be applied without the specific intention of increasing the mass range. Specifically, a relatively high frequency lowers the q_{eject} by only a very small amount, but can improve mass resolution. An interesting example is the cylindrical ion traps developed by Cooks et al. [Wells J M, Badman E R, Cooks R G, A Quadrupole Ion Trap with Cylindrical Geometry Operated in the Mass-Selective Instability Mode, Anal. Chem. 70 (1998) 438-444]. These simpler geometries, while easier to construct than the quadrupole traps, do carry contributions from higher order fields that can degrade mass resolution. For example, when the parameters for the cylindrical geometry are very similar to those of the standard quadrupole traps, the resulting mass range is about 600 Da. The supplemental RF at 425 kHz is close to half the fundamental RF frequency and does not result in an appreciable extension of the mass range. However, it does provide the improvement in mass resolution that comes from operation in the resonance ejection mode.

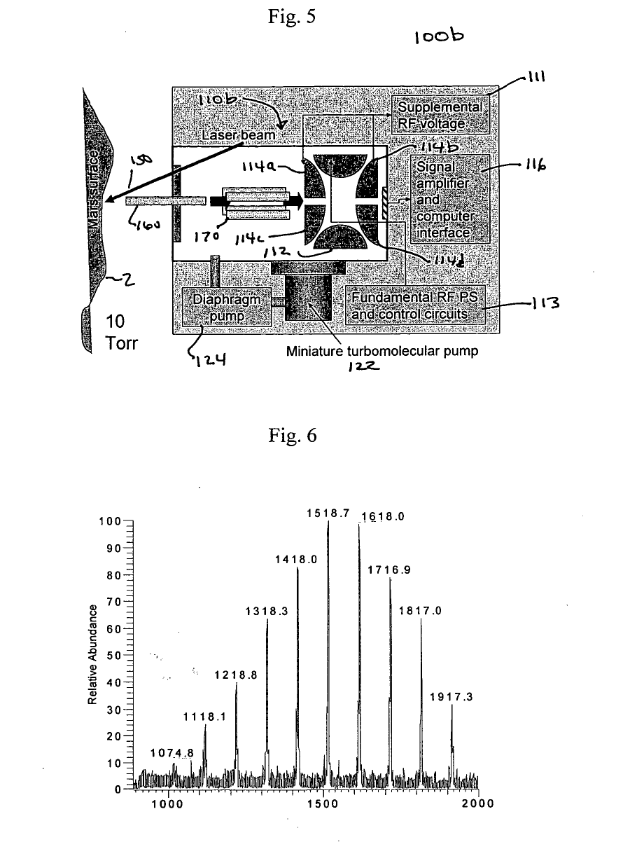

Referring now to the various figures of the drawing wherein like reference characters refer to like parts, there are shown in FIGS. 4 and 5 two embodiments of a mass spectrometry apparatus 100a,b according to the present invention. As indicated herein, a mass spectrometry apparatus 100a,b of the present invention is suitable for use in space applications as well in any of a number of other applications such as those described further herein. Thus, while the following discussion regarding FIGS. 4 and 5 make reference to a particular space application, namely mass detection on Mars, this shall not be considered as limiting the present invention to the described application.

Such mass spectrometry apparatuses 100a,b include an ion trap 110a,b that is disposed in a vacuum chamber 120 and a detector means 116 as is known to those skilled in the art that detects ions coming from the ion trap and provides a signal output of the detected ions. As is known to those skilled in the art, the signal output(s) is utilized to develop a mass spectrum that is representative of the sample being analyzed. Such a detector means 116 also typically includes an amplifier that amplifies the signal output that can be supplied to a computer for analysis via a computer interface.

A vacuum system is provided to maintain vacuum level conditions within the vacuum chamber 120. In an illustrative embodiment, such a vacuum system includes a turbomolecular pump 122 and a diaphragm pump 124 as is known to those skilled in the art, which can develop and maintain the vacuum conditions under all operating modes of the ion trap. In the case where the mass spectrometry apparatus of the present invention is in a vacuum environment, it is within the scope of the present invention for the vacuum system to be replaced with a connection to the vacuum environment.

In all embodiments, the respective ion trap 100a,b embodied in the mass spectrometry apparatus 100a,b is a low voltage instrument that utilizes a compact geometry with dimensions sufficient to easily enable the application of a supplementary RF voltage from a supplemental RF voltage source 111. As is known to those skilled in the art, the fundamental RF power source means 113 is any of a number of RF voltage sources known to those skilled that can be connected to the ring electrode 112 so as to provide the quadrupole field for trapping the ions within a storage region or volume 101 having a radius (r₀) and a vertical dimension (z₀). The field required for trapping the ions is formed by coupling the RF voltage between the ring electrode 112 and two end cap electrodes 114c,d, which are typically common mode grounded. It should be recognized that is within the skill of those in the art to adjust these dimensions, based on the teachings herein to arrive at dimensions that are suitable for the desired fundamental mass range for the ion trap 110a,b. In particularly illustrative exemplary embodiments, the radius (r₀) and vertical dimension (z₀) are about 0.5 cm. In more particular embodiments, r₀ is less than 1 cm and z₀ is less than 1 cm; r₀ is less than about 0.8 cm and z₀ is less than about 0.8 cm; r₀ is less than 0.7 cm and z₀ is less than 0.8 cm; or r₀ is about 0.5 cm and z₀ is about 0.5 cm.

In the present invention low voltage shall be understood to mean a fundamental RF voltage that is less than 1,000 v, more particularly an RF voltage less than 750 v and even more particular an RF voltage less than 500 v. In an illustrative exemplary embodiment, the RF voltage is about 300 v or less. Also, the frequency of the fundamental RF voltage is established so as to yield the desired fundamental mass range for the ion trap 110a,b. In illustrative exemplary embodiments, the fundamental RF frequencies are 1.0 and 1.1 MHz respectively and which, in combination with the above described exemplary radius and vertical dimensions, yield an ion trap 110a,b having fundamental mass ranges of 126 and 197 Da, respectively.

On the surface of Mars the atmospheric pressure is 10 Torr (compared with the 760 Torr of the earth's atmosphere) and it is compose primarily of carbon dioxide (CO₂). At this pressure, electrical breakdown is a major problem.

As is known to those skilled in the art, a supplemental RF voltage source 11 is coupled to the end caps 114a,b so as to supply an RF voltage at a second RF voltage amplitude and frequency between the ends caps 114a,b to resonate the trapped ions at their axial resonant frequencies. The endcaps also are arranged so that the ions can escape from the ion storage volume 101 and be detected by the detection means 116. Preferably, the frequencies of the supplemental RF power source 111 are established so as to yield a low q_{ejec} value that increase the effective mass range of the ion trap 110a,b so to be capable of detecting masses that are much larger than that the fundamental mass range. In particular embodiments, the frequencies of the supplemental RF power source 111 are established so as to yield q_{ejec} value that in combination with the fundamental mass range yields an ion trap having a mass range of about 1,000 Da or more, more particularly an ion trap having a mass range of about 1,500 Da or more, more particularly an ion trap having a mass range of about 2,000 Da or more, or more particularly an ion trap having a mass range of about 2,500 Da or more. In particular illustrative exemplary embodiments, the low supplemental frequencies are about 22.1 and 34.4 kHz, resulting in very low q_{ejec} values of 0.057 and 0.089, respectively and mass ranges of about 2,000 Da.

The fundamental RF power source 113 also is configured and arranged to include any of an number of control circuits or controllers as is known to those skilled in the art that controls the fundamental RF power source to allow the magnitude and/or frequency of the of the fundamental RF voltage to be varied for providing mass selection. In yet further embodiments, and as known to those skilled in the art, such control circuits or controllers also are configurable so as to be operably coupled to the supplemental power source 111 to allow the magnitude and/or frequency of the fundamental RF voltage to be varied or gated.

As is known to those skilled in the arts and as described herein, any of a number of means are utilized so as to ionize the molecules or sample for processing in the ion trap of the present invention. In the illustrated embodiments which are particularly directed to sampling on Mars, the low voltage/high mass range ion trap 100a,b of either embodiment utilizes external sample ionization using laser desorption (LD) in which a laser beam 150 is generated and directed to the surface of Mars. Ions will then enter the mass spectrometer through a micron sized aperture or capillary 160 as shown in FIG. 4. In further embodiments, the ion beam is further collimated by an RF ion guide or ion funnel 170 such as shown in FIG. 5. The general use of external laser ionization with a quadrupole ion trap is embodied in the atmospheric pressure MALDI technique such as that described in Laiko, V. V.; Moyer, S. C. and Cotter, R. J., Atmospheric Pressure MALDI/Ion Trap Mass Spectrometry, Anal. Chem. 72 (2000) 5239-5243 or Moyer, S. C. and Cotter, R. J., Atmospheric Pressure MALDI, Anal. Chem. 74 (2002) 468A-476A.

Along with the ions, these configurations result in the introduction of CO₂ gas from the Mars atmosphere. In one embodiment, the CO₂ gas is used as the bath gas in the ion trap, in place of the commonly used helium. It should be noted that heavy gases, such as argon and air can be used as bath gases in the ion trap 110a,b of the present invention and their performance compares with helium. For example, there is shown in FIG. 6 a diagrammatic view of mass spectra on a commercial ion trap mass spectrometer when using CO₂ as the bath gas. The bath gas includes any one of air, carbon dioxide, oxygen, nitrogen or a noble gas such as helium, xenon and argon. The bath gas also includes combinations of any two or more of air, carbon dioxide, oxygen, nitrogen or a noble gas such as helium, xenon and argon.

In addition, using the mass range extension provided by axial excitation on a portable, low voltage instrument also permits the use of tandem or MS/MS modes of operation in any application including space applications. In addition to the absence of high mass range, tandem operation also was not available on the low voltage Rosetta mass spectrometer. Also, MS/MS has also not been available on the miniaturized ion trap array instruments.

This mass spectrometry apparatus 100a,b as described herein specifically addresses the requirements for detecting and identifying large organic and/or biological molecules in the context of the harsh Mars environment. Specifically it provides a low power ion trap instrument for in situ measurements using a high q_{ejection} parameter to enable high mass ranges at low voltages. Thus, such an apparatus and related methods are also useful in other contexts in which the high specificity of mass spectrometry for substance identification is required in a highly portable form. Portability is enhanced by the use of the naturally occurring atmospheric gases as the ion trap bath gas, and obviates the need for an accompanying helium tank. Thus, the apparatus and methodology of the present invention would be useful for environmental monitoring, homeland security (explosives and bioagent detection), drug interdiction, drug testing (racing industry, athletes), clinical diagnostics and therapeutic monitoring.

The current technology for screening of explosives and other chemicals at airports is a surface swipe on filter paper that is analyzed on an ion mobility spectrometer (IMS). An IMS heats and then ionizes volatile components of a substance by electron ionization (EI) using either a conventional electron impact source or a beta-emitter (e.g., Ni-63). Unlike mass, which is an “intrinsic property” of a substance determined by the sum of the masses of each of the atoms in its molecular formula, ion mobilities measured by an IMS depend upon instrumental (voltage, pressure) and environmental (humidity) conditions and lack the specificity of a mass spectrometer.

The portable, low voltage ion trap 110a,b described herein can be utilized with an identical EI source, sampling volatile components, but providing a specific mass spectral signature that is matched to any number of mass spectral databases (such as the NIST/EPA/NIH mass spectral database) for positive identification. Moreover, the ion trap can be utilized in an MS/MS mode for the analysis of complex mixtures which may be present whenever a compound substance is encountered or the sample has been intentionally or unintentionally masked. In this case the ion trap 110a,b sequentially isolates, traps and fragments each component mixture providing “product ion” mass spectra that can again be matched to a library. Such measurements are currently known in the art, using commercial high performance instruments; however a portable, low power instrument with MS/MS capabilities is not.

Screening for biological agents can be accomplished in a configuration of the low power ion trap mass spectrometer that includes the pulsed laser beam and ion guide system as described in FIG. 5. Sample surfaces would likely be first coated with an organic “matrix”, such as sinnapinic acid, 2,5-dihydroxybenzoic acid (DBA), or α-cyano-4-hydroxycinnamic acid (CHCA), as part of a method known as “matrix-assisted laser desorption” or MALDI [Karas, M.; Bachmann, D.; Hillenkamp, F. (1985). “Influence of the Wavelength in High-Irradiance Ultraviolet Laser Desorption Mass Spectrometry of Organic Molecules”. Anal. Chem. 57: 2935-9]. In the case of bacterial cells and spores, the molecules specifically ionized by the laser and mass analyzed are generally small proteins or peptides that act as signatures for their identification [Hathout, Y., P. A. Demirev, Y.-P. Ho, J. L. Bundy, V. Ryzhov, L. Sapp, J. Stutler, J. Jackman, and C. Fenselau, “Identification of Bacillus spores by matrix-assisted laser desorption ionization-mass spectrometry”, Appl. Environ. Microbiol. 65 (1999) 4313-4319]. In this case, MS/MS is essential because it provides the opportunity to fragment these ion signatures and correlate with the amino acid sequences determined by the genes unique to each bacterial species. The use of external (atmospheric pressure) MALDI ionization with an ion trap is well known in a laboratory setting; however, a portable, low power configuration that brings a mass spectrometer detector (and particularly one with MS/MS capability) to the sample site is not.

Another embodiment of the apparatus and methods of the present invention involves such use for clinical diagnostics, with the small size and low power making it particularly suitable in a point-of-care setting. It is known that the alteration of biochemical pathways that occurs in disease states results in the over- or underexpression of specific proteins. The search for suitable proteins that might be exploited for diagnostics purposes, i.e. “biomarkers” is the major focus of the field of proteomics and is a daunting task considering the number of proteins found within any bodily fluid and the wide range of concentrations involved. Current methods for biomarker discovery using mass spectrometry generally combine several “orthogonal” analytical techniques, such as immunoprecipitation, size exclusion chromatography, reversed-phase chromatography and high performance tandem mass spectrometry. The end products are the identification of specific protein biomarkers, and changes in their concentrations or post-translational modifications that may disease-specific. Diagnostic tests based upon these biomarkers will generally be in the form of high volume, relatively inexpensive and disposable test kits, the most common of these being antibody-based in which a color change, the intensity of a band on a gel, or a fluorescent signal is used to indicate either a positive or negative result.

While mass spectrometers are now being used widely for biomarker “discovery” they are not widely exploited for diagnostic purposes, as such mass spectrometers are generally very expensive instruments intended to provide exhaustive analysis of complex samples. However, mass spectrometers may be used in conjunction with antibodies that isolate from these complex biofluids and present to the mass spectrometer only those proteins (peptides) that are disease relevant. In this case the mass spectrometer apparatus of the present invention provides two specific advantages: (1) the inherent mass of the biomarker obviates the need for a color or fluorescent label, and (2) the test can be carried out in multiplex using an antibody cocktail that simultaneously presents a wide panel of disease biomarkers to the mass spectrometer that can be distinguished by their masses. Because these biomarkers have already been identified and validated, and the mass spectrometer is required only to confirm their presence or absence in the biofluids of a patient, mass spectral performance requirements (such as mass resolution) are considerably reduced, suggesting that a smaller, portable mass spectrometer might be used in such a setting. The low power ion trap has considerable potential as such an instrument, as it provides sufficient mass range to encompass diagnostic peptide fragments while providing the greater specificity for distinguishing peptides with the same mass from their amino acid sequence (MS/MS) spectra.

A specific example which is envisioned, is the set of so-called “Class I MHC-associated peptides” that are normally presented on cell surfaces for interrogation by the body's immune system. Inside the cell, proteosomes cleave large proteins into nine amino acid pieces that are carried to the cell surface bound to the large MHC (major histo-compatibility) molecule. An entire peptide display can be captured by a single antibody to a major MHC type (e.g., the human leukocyte antigen, or HLA, molecule), and the nine-amino acid peptides can then be released and presented in multiplex fashion to the mass spectrometer. These nine-amino acid peptides, representing a number of diseases, conditions or infection, will all have masses that range between 900 and 1500 daltons. Some (fortuitously) will have the same mass, and will require the MS/MS capability for distinguishing these biomarkers. The low power ion trap mass spectrometer described here provides the unique opportunity for this capability in a portable or point-of-care setting.

### Example

### Basic Design Parameters

Commercial trap electrodes, ion optics, and the electron source from a Thermo Electron GCQ Plus mass spectrometer were removed and used inside a home-built vacuum chamber. The trap retained the commercial stretched geometry, that is an r₀=0.707 cm and a z₀=0.783 cm. It is important to note that this configuration does not comply with the final trap dimensions of Mars Organic Mass Analyzer (MOMA), which will make use of an even smaller r⁰ of 0.5 cm to extend the mass range. Rather, readily available commercial hardware was used to demonstrate the concepts of supplemental frequency scanning, mass range extension with low RF voltages, and internal electron ionization. The rhenium filament of the electron filament assembly was powered by an HP1050 constant current power supply (Agilent, Santa Clara Calif.). Electron emission was maintained from 1-10 μA on the electron lens. No means of automatic gain control was employed. Ions were injected by the ion gate lens for 1-10 ms and allowed to cool inside the trap for 30-39 ms before the scan was applied.

A prototype radiofrequency generator from MassTech, Inc. (Columbia, Md.) was used to apply a constant RF voltage (50-500 V₀₋ₚ depending on the scan) to the ring electrode with a frequency of 760 kHz. A Stanford Research Systems (Sunnyvale Calif.) Model DS345 Function Generator through a balun transformer (North Hills, Syosset N.Y.) produced a variable amplitude bipolar frequency sweep to opposite endcap electrodes. No phase coupling was maintained between the fundamental and supplemental RF power supplies. Triggering of each scan was maintained by a Stanford Research Systems (Sunnyvale, Calif.) DG535 delayed pulse generator, which was also used to control the gates of the electron lens, filament bias, and the ion optics lens. Frequency scan lengths lasted ˜270 ms. Amplitude modulation of both the supplemental and fundamental waveform was achieved by a National Instruments (Austin Tex.) PCI-6221 DAQ card.

Microchannel plates from Hamamatsu Corporation (Hamamatsu City, JP) were used for ion detection and operated in a pulse counting mode. Approximately 500 scans were accumulated for each spectrum by a multi-channel scaler (SR430, Stanford Research Systems) and collected through a GPIB connection (National Instruments, Austin, Tex.) for subsequent processing.

### Calibration and Instrument Operation:

Perfluorotributylamine (PFTBA), a common calibrant for EI mass spectra, was used in most experiments, while Xe isotopes and PSS-Octakis(dimethylsyliloxy)-substituted Silsesquioxane (Sigma) were used for mass resolution and mass range measurements, respectively. Volatile samples were introduced via a Teflon gas line to the ion source volume through a leak valve (Granville Phillips) with sample pressures typically maintained around 2×10⁻⁶ Torr. Solid samples were introduced to the external ion source volume with a home-built assembly employing a cartridge heater (Hotwatt, Danvers, Mass.). Both helium and carbon dioxide were used as buffer gases and maintained at approximately 2×10⁻⁵ Torr (uncorrected outside of the trap).

In the mass-selective instability mode of operation (which uses only the fundamental frequency Ω applied to the ring electrode), the maximum mass that can be scanned out of the ion trap is:

$${( m / z )}_{max} = \frac{4 {V}_{max} e}{{q}_{eject} {Ω}^{2} ( {r}_{0}^{2} + 2 {z}_{0}^{2} )} \qquad ( 1 )$$

where Vₘₐₓ is the maximum amplitude of the fundamental RF voltage, r₀ is the inside radius of the ring electrode, z₀ is the distance from the trap center to endcap, and q_{eject} is the ejection parameter.

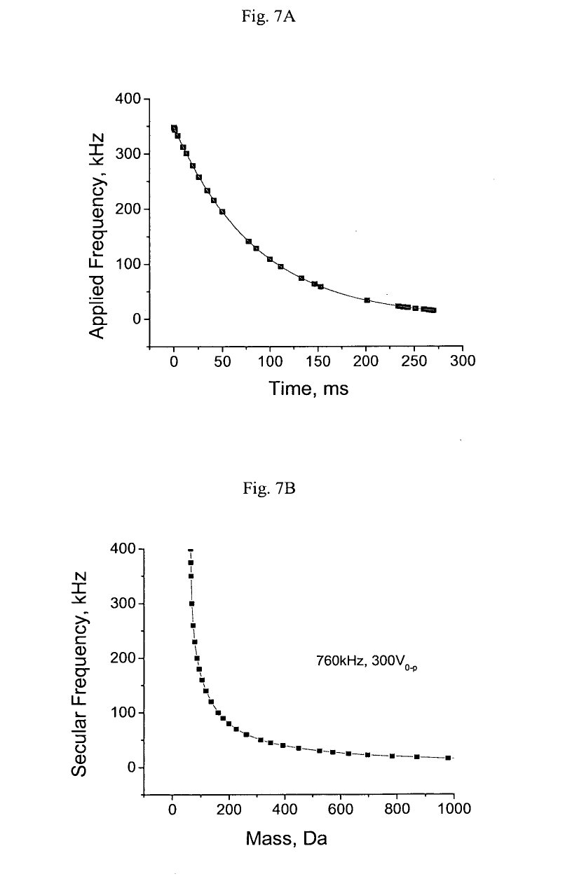

Two sweep modes are possible on the DS345 frequency generator, linear and logarithmic in time. Most scans were performed with the logarithmic sweep (see FIG. 7A). However, the formula for the fundamental supplemental frequency:

$${ω}_{z} = \frac{1}{2} {β}_{z} Ω \qquad ( 2 )$$

and the Dehmelt approximation of the parameter β_{z} for q_{z}<0.4

$${β}_{z} \approx \sqrt{\frac{1}{2} {q}_{u}^{2}} \qquad ( 3 )$$

with equation 1, yield the relation

$$ω ∝ \frac{1}{m} \qquad ( 4 )$$

suggesting that an inverse frequency sweep in time would simplify the interpretation of the raw mass spectrum. Calculated secular frequencies from ITSIM 5.0 (Aston Labs, Purdue Ohio) for various masses use a more robust formula for β in FIG. 7B for an RF voltage amplitude of 300 V₀₋ₚ. These points are then used to produce a polynomial fit between frequency and mass. For different RF voltage amplitudes, a different fit must be calculated. The conversion from time to secular frequency (the fit of FIG. 7A) and then from secular frequency to mass (the fit of FIG. 7B) permits the theoretical mass assignments of the frequency scanned spectra. When covering a small range of masses, a linear sweep could suffice. However, to scan a reasonably wide mass range, the practical application of a supplemental frequency sweep would scan the frequency in a non-linear fashion and preferably inversely with respect to time to maintain consistent mass scanning rates. Such an inverse frequency sweep may be performed in the future with an arbitrary waveform generator but was approximated by the logarithmic sweep for the data presented herein.

### External and Internal Electron Ionization Modes:

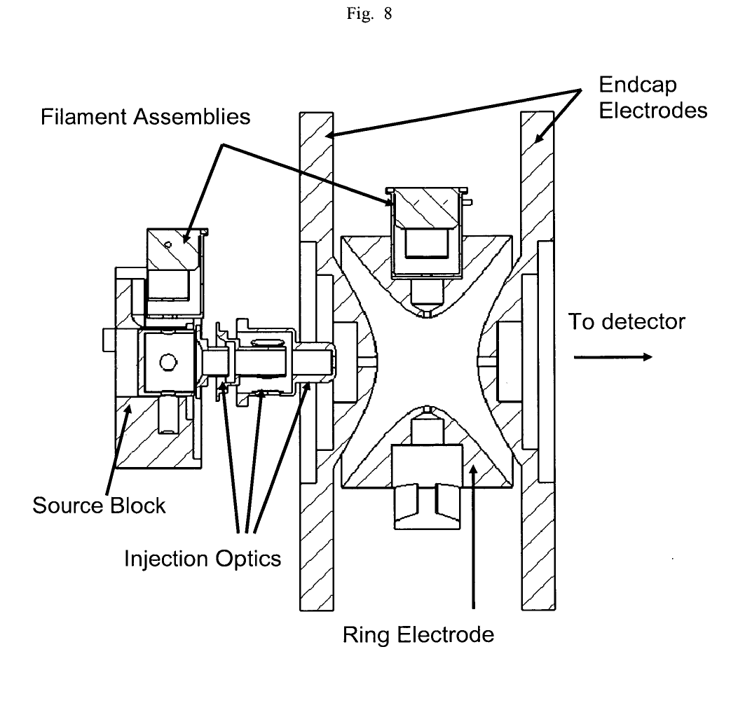

The MOMA mass spectrometer is designed to accommodate both an LD and an EI source. While a number of instrumental configurations can be envisioned to satisfy this requirement, one approach is to utilize one of the endcap electrodes as the means to admit ions formed externally by laser desorption and to form ions by electron ionization internally using an electron beam admitted into the ion trap through the ring electrode. Internal ionization by electron impact was utilized in early ion trap mass spectrometers, but was carried out by mounting an electron source on one of the endcap electrodes, which in those instruments were at ground potential. FIG. 8 is a schematic drawing of a prototype instrument which shows the placement of both the conventional external EI source and an electron source for internal ionization mounted on the ring electrode. The electron source mounted on the ring electrode utilizes a duplicate electron gun assembly identical to that on the external ion source. However, because the ring electrode carries the fundamental frequency during the ionization period some accommodation must be made for biasing the electron source and switching the electron beam on and off. One approach is to float the electron source at the RF voltage to maintain constant electron energy with respect to the ring electrode. The approach used here, however, recognizes the fact that trapping voltages for internal ionization in the mass range for GCMS will be of the order of 100-200 V₀₋ₚ. The filament is then biased at −60V (with respect to ground) when the electron beam is turned ON, and +160V to +240V when the electron beam is OFF. When turned ON this biasing scheme results in a train of electron beam pulses entering the trap (synchronous with the fundamental RF frequency), but does not appear to adversely affect ionization.

### Results & Discussion

### PFTBA and Xenon Using External EI Source:

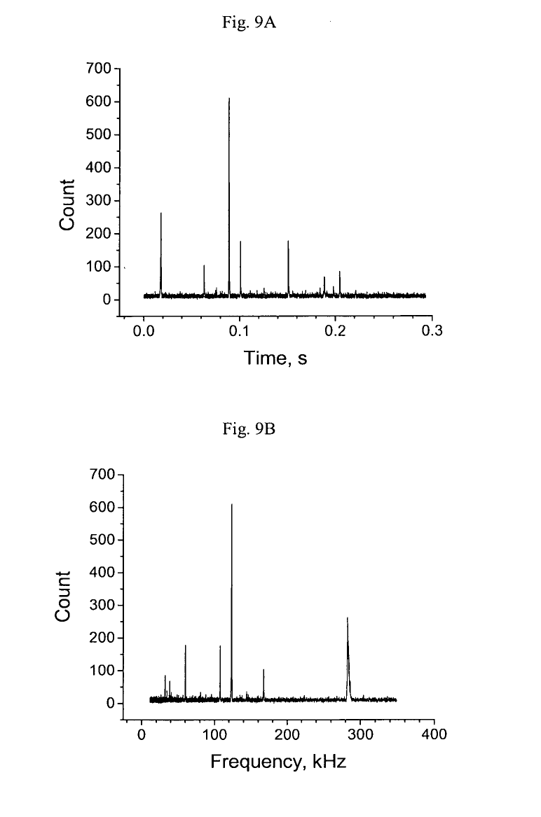

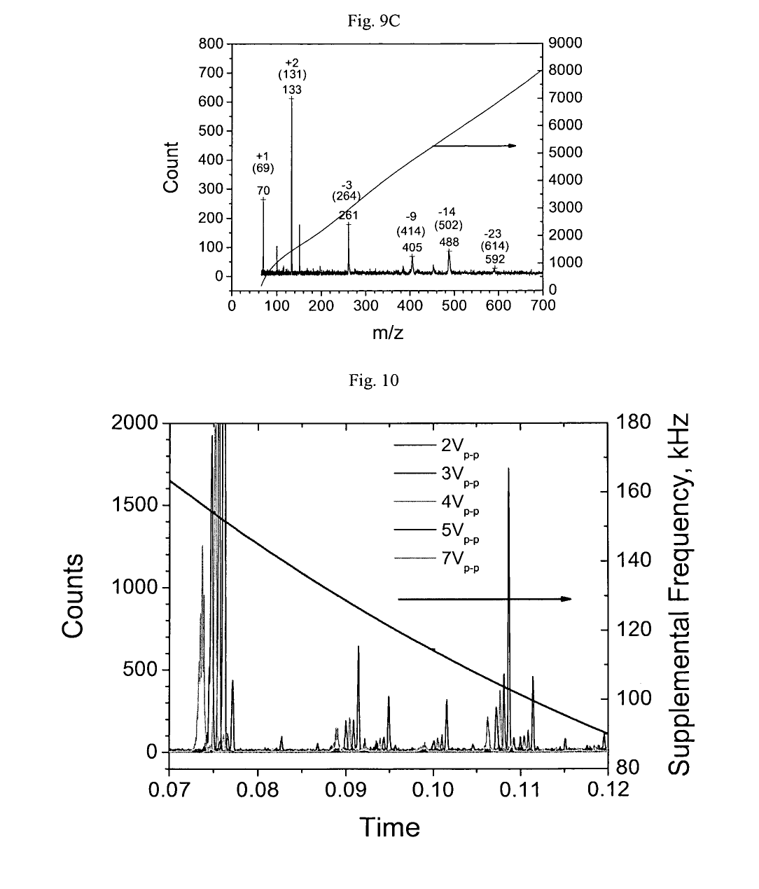

In the first experiments the external EI source was used, the headspace gas from a PFTBA sample was introduced into the ion source, and ions were injected through the grounded encaps or endcap electrodes of the trap with a trapping voltage of 300 V₀₋ₚ. After ˜30 ms of cooling, a bipolar 2 Vpp waveform was applied to opposite endcaps with the frequency scanned logarithmically from 350 kHz to 15 kHz, representing a mass range from the low mass cut-off (LMCO) limit of 64 Da to 1045 Da. There is shown in FIG. 9A the raw spectrum of PFTBA, which is then transformed into the frequency spectrum FIG. 9B and finally transformed into the mass spectrum FIG. 9C. The frequency spectrum is measured over the length of the scan and fit with a third-order polynomial. The mass scale is derived from the primary secular frequencies calculated in ITSIM 5.0. The mass spectrum shows the clear mass range extension from 64 Da using a 300V, 760 kHz RF supply to up to 600 Da by incorporation of the resonance ejection frequency scanning mode.

A direct consequence of logarithmically sweeping the supplemental resonance ejection frequency may be seen in the change in resolution across the mass spectrum. As only an approximation to the inverse frequency sweep, the logarithmic sweep still amounts to a non-uniform scan rate. Slow mass scan rates are well known to improve resolution. The fitted polynomial relation of mass over time was derivatized to produce the almost linear increase in mass scan rates shown on the right side of FIG. 9C. Early in the spectrum, the peaks are very tight, owing to the relatively slow mass scan rate but toward the end of the spectrum much faster scan rates prevail indicated by the wide peak widths. For instance, at the peak assignment of m/z 70 with a resolution of ˜300, the instantaneous scan rate is 340 Da/s but at m/z 591, the resolution is ˜130 and the instantaneous scan rate is approximately 6800 Da/s.

The major peaks of the spectrum were assigned to the characteristic EI spectral peaks of PFTBA, namely masses of 69, 131, 264, 414, 502, and 614 shown in parentheses. For example, the last visible peak, appearing theoretically at 591 Da is presumed to be the m/z 614 peak of PFTBA. Assuming the correct assignment of the peaks, the mass spectrum notably exhibits several dramatic mass “shifts” (noted in FIG. 9). While some small (<1 Da) mass shifting can be owed to space charge and/or buffer gas effects, the extremely large shifts are remarkable in the high mass region reaching up to −23 Da for m/z 614. This can probably be explained by different ejection conditions for ions having different masses (as will be illustrated later in FIG. 10). Such a large degree of mass shifting emphasizes the need for calibration standards in practical operation of the frequency scanning mode.

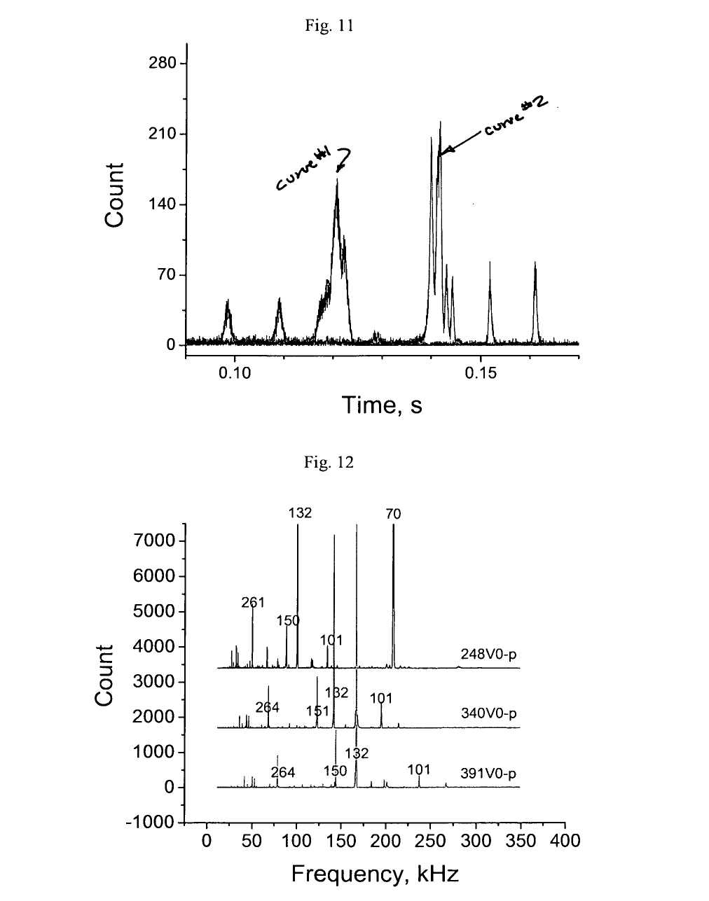

The amplitude of the supplemental waveform is varied in FIG. 10 for PFTBA. Frequencies were scanned logarithmically in time from 375 kHz to 15 kHz, in a “forward” scanning manner from low to high mass, while the fundamental RF voltage is held constant at 151 V₀₋ₚ. Ions clearly eject earlier at higher frequencies with higher AC amplitudes. This means that the ejection conditions (namely, the amplitude of the supplemental excitation voltage) can affect the ejection time. The “optimal” excitation voltage amplitude should not be very different from the “threshold” value, thus, leaving us the room for amplitude optimization in the future. In FIG. 11, the effect of higher order electric fields on the resolution dependence in the forward and reverse scan directions is shown. The raw spectra are shown for both scan directions for a sample of xenon gas. In the forward scan (curve #2), the isotopes of xenon are noticeably distinguishable. The positive octopole component of the commercial configuration causes the ions approaching the endcaps (high amplitude) to increase their secular frequency. The ions thus experience the higher secular frequencies with the decreasing applied supplemental AC frequency, helping to quickly push the ions into resonance in the forward scanning mode. In the reverse scan (curve #1) going from 15 kHz to 350 kHz, a blurred peak denotes the waffling of the ions' secular frequency approaching the endcaps.

The highest observed mass in FIG. 10 is a peak at a frequency of 19.26 kHz, assigned to the 414 Da fragment of PFTBA. Larger peaks including the 614 Da and 502 Da peaks are conspicuously absent presumably due to the shallow potential energy well depth which complicates trapping. According to the Dehmelt approximation, the pseudopotential well depth of an ion of mass 502 Da is ˜1.1 eV (q=0.059), while that of the observed ˜414 Da is 1.3 eV (q=0.072). Such shallow well depths prove to be a limiting factor as it decreases with higher mass. Unlike the frequency scans of Ding and co-workers [L. Ding, M. Sudakov, F. L. Brancia, R. Giles, S. Kumashiro, A digital ion trap mass spectrometer coupled with atmospheric pressure ion sources. J. Mass Spectrom. 39 (2004) 471-484] in which the instability point remains constant across the scan, maintaining a single potential well depth, our configuration scans the instability point and thus the potential well depth is not constant across all masses. However, such a calculation does provide some insight on the limitation of resonance ejection to extend the mass range.

To increase the well depth for higher masses (lower q), the trapping voltage can be raised. In FIG. 12, the consequence of using higher trapping voltages is a higher low mass cut-off as evidenced by the loss of the ˜69 m/z peak at voltages above 248V0-p. The higher trapping voltages do not result in noticeably increased high mass sensitivity though this may simply reflect the relatively low intensity of the high mass region of PFTBA. An optimization of the operating mass modes (by varied trapping voltage) must balance high mass sensitivity with the low mass cut-off.

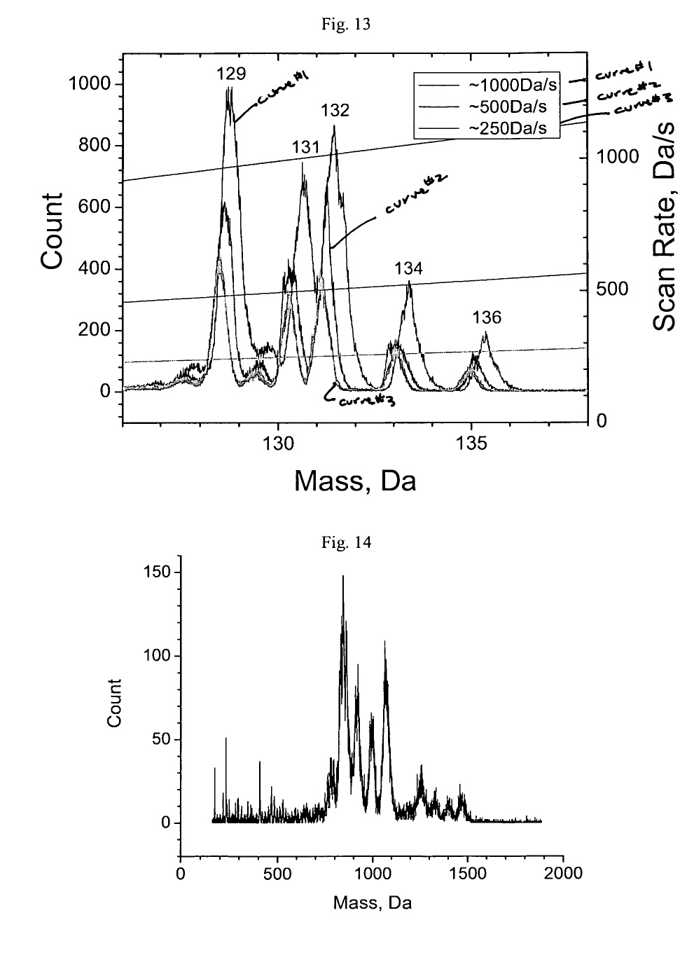

In FIG. 11, the relatively poor resolution of even the forward scanned spectrum is achieved with a scan rate of approximately 1400 Da/s, already four times slower than the commercial scan rates of ˜5000 Da/s. Even slower scan rates were employed to demonstrate the capacity for enhanced resolution in FIG. 13. Some moderate gains in resolution were achieved with scan rates 1000, 500, and 250 Da/s by simply increasing the length of the scan. The isotopes 131 and 132 are baseline resolved in the slowest scan. We believe further improvements in the resolution can be accomplished with a more stable fundamental RF power supply. Instability in the amplitude of the fundamental RF power supply employed have been observed as high as 6 Vₚ₋ₚ which for high q values like the instability boundary of 0.908 evokes a mass assignment error of ˜0.7 Da but at a q value as low as 0.2, produces an error of 3 Da. Notably, the commercial RF power supply used was originally developed for simpler quadrupole mass filter applications.

### Higher Mass Ranges:

PSS-Octakis(dimethylsyliloxy)-substituted silsesquioxane, a higher mass compound (MW 1017) which is mildly volatile at room temperature, was chosen for the relative large high mass to low mass ion abundance in its EI spectrum to examine higher mass ranges. In this case, a fundamental RF amplitude of 300 V₀₋ₚ was used on the ring electrode, while the supplemental RF on the endcaps of 4 Vₚ₋ₚ was scanned logarithmically from 100 kHz to 10 KHz. Solid sample was desorbed from a heater at ˜52° C. directly into the external EI source, and its mass spectrum recorded as in FIG. 14. Such an observation shows a promising mass range extension using q values as low as 0.037.

Internal Electron Ionization through the Ring Electrode with CO₂ as the Bath Gas:

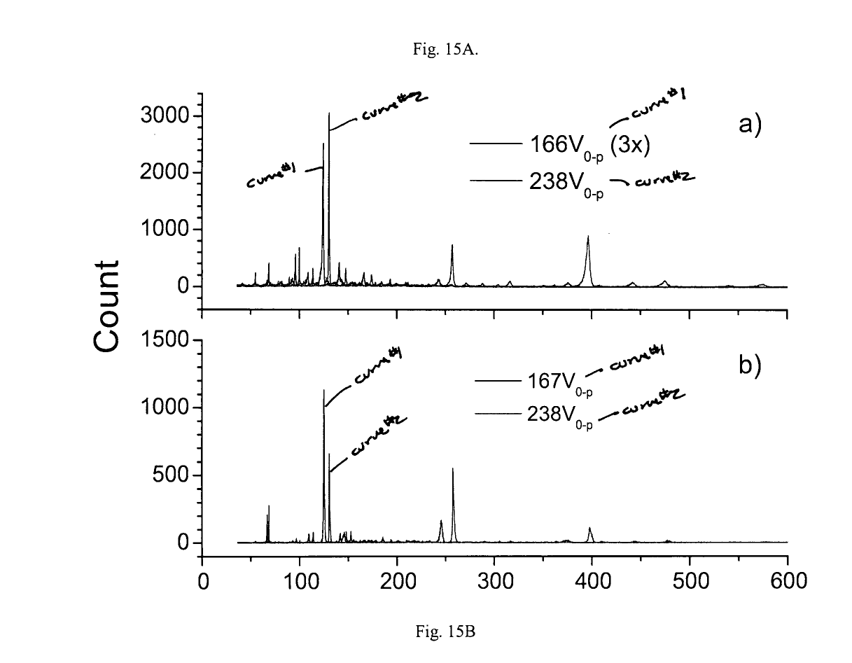

The prototype enabled us to develop the capability for internal ionization using an electron beam entering through the ring electrode and to test the possibility for using carbon dioxide (the major constituent of the Mars atmosphere) as a bath gas for cooling and trapping the ions. A comparison of the spectra of PFTBA obtained with the internal and external EI sources using CO₂ as the bath gas is shown in FIGS. 15A,B. In the internal ionization mode shown in FIG. 15A, the filament “Off” bias condition is set to be approximately consistent with the trapping voltage amplitude. Thus, the red trace (curve #2) of FIG. 15A shows the mass spectra with trapping voltage at 237.5 V₀₋ₚ and the ON/OFF bias set at −60/+240V. In the black trace (curve #1) of FIG. 15A the trapping voltage is reduced to 166.5 V₀₋ₚ and the filament ON/OFF bias to −60/+160V. In this case, the higher mass ion signal is reduced while the low mass cutoff is also reduced to include ions at the low mass end of the spectrum. In the external ionization mode in FIG. 15B similar results are observed at trapping voltages of 166.5 V₀₋ₚ and 237.5 V₀₋ₚ in the black (curve #1) and red (curve #2) traces, respectively. Many of the major mass peaks are observed in both external and internal configurations using CO₂. Some additional peaks in the case of internal ionization may be related to the ionization of CO₂ itself inside the trap at least in the case of the sample of perfluorotributylamine. As expected, the internal ionization method results in better overall signal intensities.

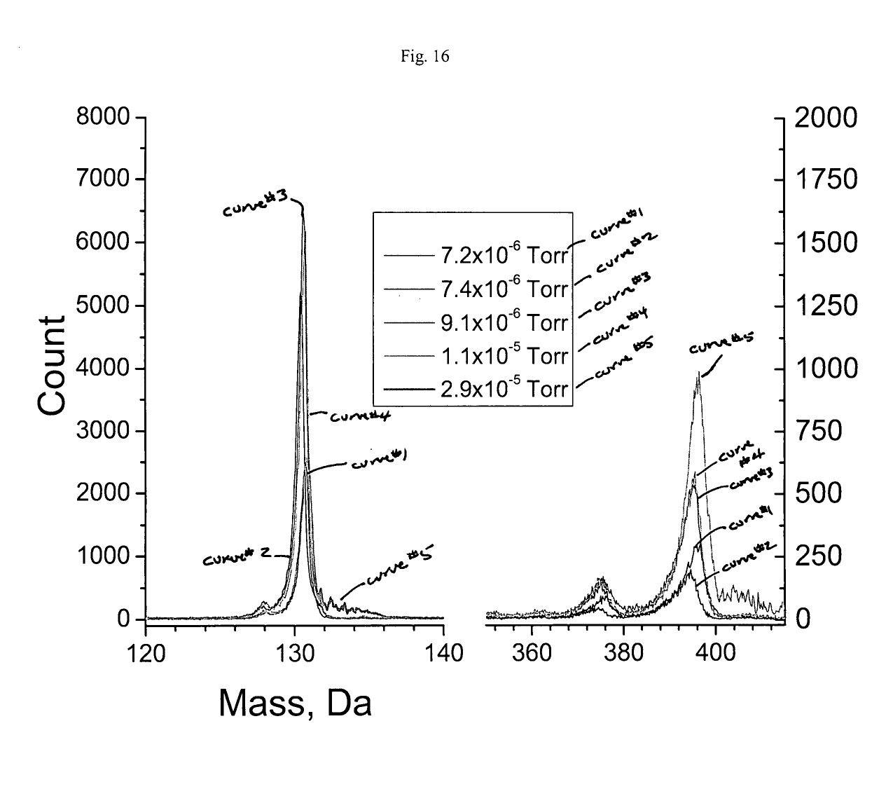

The pressure of CO₂ inside the ion trap, when used as the bath gas, cannot be directly determined in the instrument. Therefore, a series of experiments were preformed in which the CO₂ pressure was varied and measured in the vacuum chamber outside the ion trap. As shown in FIG. 16, the pressure ranged from 7.2×10⁻⁶ Torr to 2.9×10⁻⁵ Torr. In general, higher CO₂ pressures showed an increase in the intensity of the ion signal at m/z 414 relative to the signal at m/z 131.

### CONCLUSIONS

The constraints of size, weight and power for the upcoming Mars mission dictated the need for the development of a compact instrument operated at low voltage and low RF power. In this case miniaturization is not the goal; rather it is the ability to record masses in a range that might suggest the existence of organic or biological molecules. In the current prototype it has been shown that the use of a supplemental RF frequency on the endcaps can extend the mass range on a 300V instrument. The choice of 300V as the fundamental RF amplitude in this case reflects the 300 volts used earlier in the Rosetta mission where a mass range of 150 was achieved using the mass selective instability mode only. Scanning the supplementary frequency (rather than the fundamental RF amplitude) also helps to reduce the need for high voltage and power, as ions can be ejected at voltages just sufficient to trap the ions. Supplemental frequency scanning also decouples the power-mass range relationship by obviating the need for precise amplitude control of a high voltage RF. While different mass scanning modes are anticipated, the electronics are still greatly simplified requiring only precise frequency control of the low voltage waveforms. In addition, a novel design that enables input of the electron beam through the ring electrode offers the practical possibility of incorporating up to four redundant filaments. We do note that one disadvantage of an internal source is the potential build up of contamination from the effluent flow of the gas chromatograph. However, the limited number of GC runs that are planned in this scenario limit the extent of contamination anticipated. Furthermore, calibrations are expected to be performed at frequent intervals to account for mass shift complications.

Although a preferred embodiment of the invention has been described using specific terms, such description is for illustrative purposes only, and it is to be understood that changes and variations may be made without departing from the spirit or scope of the following claims.

### INCORPORATION BY REFERENCE

All patents, published patent applications and other references disclosed herein are hereby expressly incorporated by reference in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

1. A quadrupole ion trap for mass spectrometry, comprising:
a ring electrode having an aperture;
a plurality of end cap electrodes that are arranged so at least one endcap electrode is opposed to the ring electrode aperture;
a first RF power supply that is operably coupled to the ring electrode so as to form a quadrupole filed for trapping ions within a storage volume defined by said field;
a second RF power supply that operably coupled to a pair of end cap electrodes;
wherein the first RF power supply supplies a first RF voltage having an amplitude less than or equal to 1,000 v; and
wherein the second RF power supply supplies a second RF voltage, the second voltage having a voltage and/or frequency set so that the ion trap exhibits a mass range from about 0 Da to at least about 1,000 Da.

2. The quadrupole ion trap according to claim 1, wherein the first RF voltage has an amplitude less than or equal to about 750 v.

3. The quadrupole ion trap according to claim 1, wherein the first RF voltage has an amplitude less than or equal to about 500 v.

4. The quadrupole ion trap according to claim 1, wherein the first RF voltage has an amplitude less than or equal to about 300 v.

5. The quadrupole ion trap according to claim 1, wherein the second RF voltage and/or frequency is established so that the ion trap exhibits a mass range from about 0 Da to at least about 1,500 Da.

6. The quadrupole ion trap according to claim 1, wherein the second RF voltage and/or frequency is established so that the ion trap exhibits a mass range from about 0 Da to at least about 2,500 Da.

7. The quadrupole ion trap according to claim 1, wherein the frequency of the second RF voltage is set so as to yield a _{q ejec} value that in combination with the mass range established by the first RF voltage yields an ion trap having a mass range from about 0 Da to at least about 1,000 Da.

8. The quadrupole ion trap according to claim 1, wherein the frequency of the second RF voltage is set so as to yield a _{q ejec} value that in combination with the mass range established by the first RF voltage yields an ion trap having a mass range from about 0 Da to at least about 1,500 Da.

9. The quadrupole ion trap according to claim 1, wherein the frequency of the second RF voltage is set so as to yield a _{q ejec} value that in combination with mass range established by the first RF voltage yields an ion trap having a mass range from about 0 Da to at least about 2,000 Da.

10. The quadrupole ion trap according to claim 1, wherein the frequency of the second RF voltage is set so as to yield _{q ejec} value that in combination with the mass range established by the first RF voltage yields an ion trap having a mass range from about 0 Da to at least about 2,500 Da.

11. The quadrupole ion trap according to claim 1, wherein the radius of the ring electrode aperture (rₒ) and the distance from a center of the ion trap (zₒ) and the endcap electrode are established such that these values combined with the frequency and amplitude of the first RF voltage establish a first mass range.

12. The quadrupole ion trap according to claim 11, wherein rₒ is less than 1 cm.

13. The quadrupole ion trap according to claim 11, wherein rₒ is less than about 0.8 cm and zₒ is less than about 0.8 cm.

14. The quadrupole ion trap according to claim 11, wherein rₒ is less than 0.7 cm and zₒ is less than 0.8 cm.

15. The quadrupole ion trap according to claim 11, wherein rₒ is about 0.5 cm and zₒ is about 0.5 cm.

16. The quadrupole ion trap according to claim 1, further comprising a bath gas that is disposed in the storage volume, the bath gas being helium.

17. The quadrupole ion trap according to claim 1, further comprising a bath gas that is disposed in the storage volume, the bath gas being carbon dioxide.

18. The quadrupole ion trap according to claim 1, further comprising a bath gas that is disposed in the storage volume, the bath gas including any of air, carbon dioxide, oxygen, nitrogen, a noble gas such as helium, xenon and argon or combinations thereof.

19. A mass spectrometry apparatus for providing one or more outputs representing a mass analysis of a sample, said mass spectrometry apparatus comprising:
a quadrupole ion trap according to claim 1;
means for ionizing the sample, said means being operably coupled to said quadrupole ion trap such that the ionized sample is trapped in the storage volume;
means for detecting ions and providing an output signal representative of the detected ions; and
means for controlling the quadrupole ion trap so as to cause one or more ions to be ejected from the storage volume to the detector.

20. A mass spectrometry apparatus for providing one or more outputs representing a mass analysis of a sample, said mass spectrometry apparatus comprising:
a quadrupole ion trap for mass spectrometry, said ion trap including:
a ring electrode having an aperture,
a plurality of end cap electrodes that are arranged so at least one endcap electrode is opposed to the ring electrode aperture,
a first RF power supply that is operably coupled to the ring electrode so as to form a quadrupole field for trapping ions within a storage volume defined by said field,
a second RF power supply that operably coupled to a pair of end cap electrode;
wherein the first RF power supply supplies a first RF voltage having an amplitude less than or equal to 500V,
wherein a radius of the ring electrode aperture (rₒ) is about 0.5 cm and a distance (zₒ) from a center of the ion trap and the endcap electrode is about 0.5 cm and where these values combined with the frequency and amplitude of the first RF voltage establish a first mass range,
wherein the second RF power supply supplies a second RF voltage to the pair of endcap electrodes, the second RF voltage having a frequency set so as to yield a q_{eject} value that in combination with the first mass range yields an ion trap having a overall mass range from about 0 Da to at least about 1,000 Da. means for ionizing the sample, said means being operably coupled to said quadruple ion trap such that the ionized sample is trapped in the storage volume;
means for detecting ions and providing an output signal representative of the detected ions; and
means for controlling the quadrupole ion trap so as to cause one or more ions to be ejected from the storage volume to the detector.

21. The mass spectrometry apparatus of claim 20, wherein the frequency of the second RF voltage is set so as to yield a q_{eject} value that in combination with the first mass range established yields an ion trap having an overall mass range from about 0 Da to at least about 1,500 Da.

22. The mass spectrometry apparatus of claim 20, wherein the frequency of the second RF voltage is set so as to yield a q_{eject} value that in combination with the first mass range yields an ion trap having an overall mass range from about 0 Da to at least about 2,000 Da.

23. The mass spectrometry apparatus of claim 20, wherein the frequency of the second RF voltage is set so as to yield a q_{eject} value that in combination with the first mass range yields an ion trap having a mass range from about 0 Da to at least about 2,500 Da.

24. A method for mass analyzing a sample comprising the steps of:
providing a quadrupole ion trap according to claim 1;
ionizing the sample;
trapping the ionized sample in the storage volume of the quadrupole ion trap;
controlling the quadrupole ion trap so as to cause one or more of the trapped ions to be ejected from the storage volume; and
detecting the ejected ions and providing an output signal representative of the detected ions.
